(19) United States
(12) Patent Application Publication
(10) Pub. No.: US 2025/0327193 A1
(43) Pub. Date: Oct. 23, 2025

(54) ELECTROLYTE COMPRISING SOLVENT WITH LOW POLARITY AND METHOD OF PREPARING ELECTROCHEMICAL LITHIUM- MEDIATED AMMONIA USING THE SAME

(71) Applicant: POSTECH RESEARCH AND BUSINESS DEVELOPMENT FOUNDATION, Pohang-si (KR)

(72) Inventors: Kijung YONG, Pohang-si (KR); Hyeju YUN, Pohang-si (KR); Chaeeun LIM, Pohang-si (KR)

(21) Appl. No.: 19/175,153

(22) Filed: Apr. 10, 2025

(30) Foreign Application Priority Data
Apr. 22, 2024 (KR) 10-2024-0053384

(51) Int. Cl. C25B 1/27; C25B 11/046

(52) U.S. Cl. CPC C25B 1/27; C25B 11/046

(57) ABSTRACT

Disclosed is a electrolyte comprising solvent with low polarity and method of manufacturing electrochemical lithium-mediated ammonia using the same. In detail, an electrolyte comprising a first solvent represented by Structural Formula 1; a second solvent represented by Structural Formula 2; a metal salt; and a proton donor compound. The present disclosure can control the solvation structure through a solvent with low polarity even in a relatively low-concentration electrolyte, thereby constructing a high-performance ammonia production system.

### CROSS REFERENCE TO RELATED APPLICATION

The present application claims priority to Korean Patent Application No. 10-2024-0053384, filed on Apr. 22, 2024, the entire contents of which are incorporated herein for all purposes by this reference.

### BACKGROUND OF THE DISCLOSURE

### 1. Field of the Disclosure

The present disclosure relates to an electrolyte comprising a solvent with low polarity and method of preparing an electrochemicallithium-mediated ammonia using the same.

### 2. Description of the Related Art

Ammonia (NH₃ or NH₄⁺), one of the most widely produced and utilized chemicals, is an essential feedstock for nitrogen-based fertilizers and has recently been considered an ideal carbon-neutral fuel or hydrogen carrier with a very high hydrogen density.

Unfortunately, the current NH₃ production mainly relies on the energy-consuming (1.0-2.0% of global energy production) and waste-intensive (1.5% of global carbon emissions) Haber-Bosch process. However, the Haber-Bosch process requires high temperature and high pressure conditions, and has problems such as high carbon dioxide emissions and high energy utilization during the process.

In addition, there is a technology to increase the efficiency of ammonia synthesis by forming an inorganic SEI (solid electrolyte interphase) using a high-concentration electrolyte of the LiF (Fluorine) series. But there are problems such as the use of expensive lithium salts and high viscosity of the solution, which reduces the mobility of reactants.

Therefore, research on an electrochemical ammonia production system that can be operated in a room temperature and low pressure environment is necessary.

### SUMMARY OF THE DISCLOSURE

The purpose of the present disclosure is to solve the above problems, and to provide an electrochemical ammonia production system that controls the dissolved structure in the electrolyte by introducing a solvent with low polarity.

In addition, Another purpose of the present disclosure is to provide an electrochemical ammonia production system with improved performance by controlling the stability of the system and the composition of the electrolyte decomposition membrane by such a solvation structure.

In addition, another purpose of the present disclosure is to provide an electrochemical ammonia production system that can be operated in a room temperature and low pressure environment.

One aspect of the present disclosure provides an electrolyte comprising a first solvent represented by Structural Formula 1 below; a second solvent represented by Structural Formula 2 below; a metal salt; and a proton donor compound,

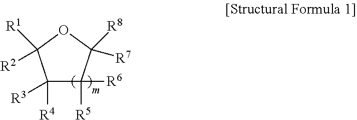

wherein R¹ to R⁸ are identical to or different from each other, and R¹ to R⁸ are each independently a hydrogen atom or a C₁-C₃ alkyl group, m is 1 or 2,

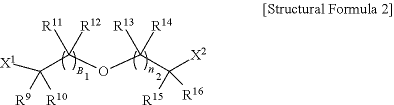

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, R¹ to R⁸ are identical to or different from each other, and R¹ to R⁸ are each independently a hydrogen atom or a methyl group, m is 1 or 2, X¹ is F, R⁹ and R¹⁰ are identical to or different from each other, and R⁹ and R¹⁰ are each independently a hydrogen atom or F, R¹¹ and R¹² are identical to or different from each other, and R¹¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 5, and n₂ is any integer from 0 to 5.

In addition, R¹ to R⁸ are each a hydrogen atom, m is 1, X¹ is F, R⁹ and R¹⁰ are identical to or different from each other, and R⁹ and R¹⁰ are each independently a hydrogen atom or F, R¹¹ and R¹² are identical to or different from each other, and R¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 3, and n₂ is any integer from 0 to 3.

In addition, the electrolyte may be used in an electrochemical ammonia production system.

In addition, the electrolyte may comprise 100 parts by weight of the first solvent represented by the Structural Formula 1; 100 to 400 parts by weight of the second solvent represented by the Structural Formula 2; 50 to 250 parts by weight of the lithium salt; and 1 to 10 parts by weight of the proton donor compound.

In addition, a volume ratio of the second solvent and the first solvent may be 0.1:1 to 9:1.

In addition, a concentration of the metal salt may be 0.5 to 5 M based on a total of the first solvent and the second solvent.

In addition, a dielectric constant of the second solvent may be smaller than that of the first solvent, and a dipole moment of the second solvent may be smaller than that of the first solvent.

In addition, the second solvent may interfere with solvation of a metal ion of the metal salt.

In addition, the metal salt may comprise at least one selected from the group consisting of a lithium salt, a zinc salt, a sodium salt, a nickel salt, a calcium salt, and a magnesium salt.

In addition, the lithium salt may comprise at least one selected from the group consisting of lithium bisfluorosulfonylimide (Li(FSO₂)₂N), LiFSI), lithium hexafluorophosphate (LiPF₆), lithium tetrafluoroborate (LiBF₄), lithium perchlorate (LiClO₄), lithium trifluoromethanesulfonylimide (LiN(CF₃SO₂)₂, LiTFSI), lithium triflate (LiCF₃SO₃), lithium difluoro(bis(oxalato))phosphate (LiPF₂(C₂O₄)₂), lithium tetrafluoro(oxalato)phosphate (LiPF₄(C₂O₄)), lithium difluoro(oxalato)borate (LiBF₂(C₂O₄)), and lithium bis(oxalato)borate (LiB(C₂O₄)₂).

In addition, the proton donor compound may comprise at least one selected from the group consisting of ethanol, methanol, isopropanol, n-propanol, n-butanol, glycol, propylene glycol, glycerol, butane diol, ammonia, formic acid, acetic acid, and water.

Another aspect of the present disclosure provides an ammonia production system comprising a working electrode, a counter electrode, a reference electrode, and an electrolyte, wherein the electrolyte comprises: a first solvent represented by Structural Formula 1 below; a second solvent represented by Structural Formula 2 below; a metal salt; and a proton donor compound,

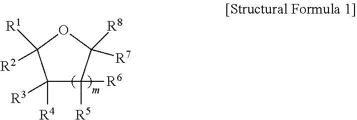

wherein R¹ to R⁸ are identical to or different from each other, and R¹ to R⁸ are each independently a hydrogen atom or a C₁-C₃ alkyl group, m is 1 or 2,

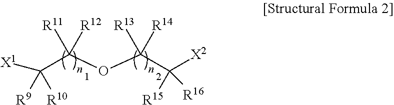

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, R¹ to R⁸ are identical to or different from each other, and R¹ to R⁸ are each independently a hydrogen atom or a methyl group, m is 1 or 2, X¹ is F, R⁹ and R¹⁰ are identical to or different from each other, and R⁹ and R¹⁰ are each independently a hydrogen atom or F, R¹¹ and R¹² are identical to or different from each other, and R¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 5, and n₂ is any integer from 0 to 5.

In addition, an ammonia may be produced at the working electrode and a hydrogen may be produced at the counter electrode.

In addition, the working electrode may comprise a nickel atom, the counter electrode may comprise a platinum atom, and the reference electrode may comprise a platinum atom.

Another aspect of the present disclosure provides a method of producing an ammonia comprising: (a) supplying an ammonia production system; and (b) supplying a nitrogen to the ammonia production system to perform a reduction reaction, thereby producing an ammonia, wherein the system comprises a working electrode, a counter electrode, a reference electrode, and an electrolyte, wherein the electrolyte comprises: a first solvent represented by Structural Formula 1 below; a second solvent represented by Structural Formula 2 below; a metal salt; and a proton donor compound,

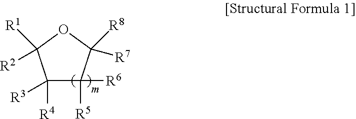

wherein R¹ to R⁸ are identical to or different from each other, and R¹ to R⁸ are each independently a hydrogen atom or a C₁-C₃ alkyl group, m is 1 or 2,

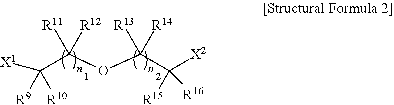

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, the reduction reaction may be carried out by lithium-mediated nitrogen reduction (Li-NRR).

In addition, a nitrogen may be supplied at a pressure of 5 to 25 bar.

The present disclosure can build a high-performance electrochemical lithium-mediated ammonia production system through the development of a low polarity solvent mixture-based electrolyte.

In addition, the electrolyte can generate a solvation structure similar to that of a high concentration even with a low-concentration lithium salt, and can increase the solubility of nitrogen, a reactant, so that it can be operated at low pressure.

In addition, the high-performance electrochemical lithium-mediated ammonia production system of the present disclosure can enable economical and efficient green ammonia production.

### BRIEF DESCRIPTION OF THE DRAWINGS

These drawings are for the purpose of describing exemplary embodiments of the present disclosure, and therefore the technical idea of the present disclosure should not be construed as being limited to the accompanying drawings:

FIG. 1A shows the reaction mechanism of Li-NRR (lithium mediated nitrogen reduction) of the present disclosure.

FIG. 1B shows the Li-NRR system of the present disclosure and the electrolyte composition of the present disclosure.

FIG. 2A shows a comparison of a local high-concentration electrolyte (LHCE) containing a hydrofluoroether antisolvent of the present disclosure.

FIG. 2B shows a Fluorinated Ether that can be used as a second solvent (antisolvent) of the present disclosure.

FIG. 3A shows a schematic diagram of the Li-NRR system of each electrolyte of Comparative Example 1 (LCE), Comparative Example 2 (HCE), and Example (LHCE) of the present disclosure.

FIG. 3B shows a solvent structure showing the ion pair of each electrolyte (LCE, HCE, LHCE).

FIG. 4A shows a schematic diagram of Comparative Example 1 (low concentration electrolyte (LCE)), Comparative Example 2 (high concentration electrolyte (HCE)), and Example 1-3 of the present disclosure (local high concentration electrolyte (LHCE)).

FIG. 4B shows ammonia yields and faradaic efficiencies at various LiTFSI concentrations at 20 bar N₂ and a current density of −40 mA/cm².

FIG. 4C shows ammonia yields and faradaic efficiencies at various solvent compositions at 1 M LiTFSI, 20 bar N₂, and a current density of −40 mA/cm².

FIG. 4D shows a comparison of ammonia yields and faradaic efficiencies between Comparative Example 1 (LCE), Comparative Example 2 (HCE), and Example 1-3 of the present disclosure (LHCE).

FIG. 4E is a schematic diagram of the dependence of the Faraday efficiency on the N₂ pressure of Comparative Example 2 (HCE) and Example 1-3 of the present disclosure (LHCE).

FIG. 5A is the Raman spectrum result of each electrolyte.

FIG. 5B is the S—N—S bending region (720˜760 cm⁻¹) result of the Raman spectrum of each electrolyte.

FIG. 5C is the FT-IR spectrum result of each electrolyte.

FIG. 5D shows a comparison of the Li-NMR results of each electrolyte.

FIGS. 6A to 6C show SEM images of LCE, HCE, and LHCE for SEI after electrochemical reaction, respectively.

FIGS. 6D to 6F show XPS spectra of Li is, F is, and S 2p for SEI in each electrolyte.

FIG. 7A shows the results of investigating the physical properties of antisolvents of the present disclosure.

FIG. 7B shows the ammonia yield and faradaic efficiency of various antisolvent-based LHCEs.

FIG. 7C shows the potential profiles of various antisolvent-based LHCEs.

FIG. 7D shows the UV-vis absorbance spectra of various antisolvent-based LHCEs after electrochemical reaction.

FIG. 7E shows the electrochemical performances of various antisolvent-based LHCEs.

FIG. 8 shows the results of the fluorinated ether addition experiment.

FIG. 9 shows the measured viscosity data of each electrolyte of Comparative Example 1 (1M, LCE in the present disclosure), Comparative Example 2 (2.35M, HCE in the present disclosure), Comparative Example 3 (3M), and Example 1-3 of the present disclosure (1M LHCE).

FIG. 10 shows the results of measuring the N₂ solubility of each electrolyte (LCE, HCE, LHCE) of Comparative Example 1, Comparative Example 2, and Example 1-3 of the present disclosure.

FIG. 11 shows that ammonia production occurs in N₂ gas with isotope test of ¹⁵N₂:¹⁴N₂=1:5 ratio.

FIG. 12A shows the ammonia yield dependence over time showing a linear relationship up to 12 hours.

FIG. 12B shows the ammonia yield at various reaction times confirmed by ¹H NMR.

FIG. 12C shows a control experiment controlling current and N₂ supply.

FIGS. 13A to 13C are SEM-EDS images of SEI in Comparative Example 1 (LCE), Comparative Example 2 (HCE), and Example 1-3 of the present disclosure (LHCE), respectively.

FIG. 14 is the working electrode images after 1 hour of electrochemical reaction at 20 bar N₂ in Comparative Example 1 (LCE), Comparative Example 2 (HCE), and Example 1-3 of the present disclosure (LHCE).

FIG. 15 shows XRD data of each electrode of Comparative Example 1 (LCE), Comparative Example 2 (HCE), and Example 1-3 of the present disclosure (LHCE) after 1 hour of electrochemical reaction.

FIGS. 16A to 16C show XPS spectra of C 1s, O 1s, and N 1s of SEI in each electrolyte of Comparative Example 1 (LCE), Comparative Example 2 (HCE), and Example 1-3 of the present disclosure (LHCE), respectively.

FIG. 17 is electrochemical impedance spectroscopy (EIS) data of each electrolyte of Comparative Example 1 (LCE), Comparative Example 2 (HCE), and Example 1-3 of the present disclosure (LHCE) before reaction.

FIG. 18 is the full Raman spectra of Comparative Example 1 (LCE), Comparative Example 2 (HCE), Example 1-3 of the present disclosure (LHCE), lithium bis(fluorosulfonyl)imide (LiTFSI), tetrahydrofuran (THF), and Example of the present disclosure (1,1,2,2-tetrafluoroethyl-2,2,3,3-tetrafluoropropyl ether, TTE).

FIG. 19A is the full FT-IR spectra of Comparative Example 1 (LCE), Comparative Example 2 (HCE), Example of the present disclosure (LHCE), tetrahydrofuran (THF), and 1,1,2,2-tetrafluoroethyl-2,2,3,3-tetrafluoropropyl ether (TTE).

FIG. 19B is the S—N vibration region of the FT-IR spectrum of each electrolyte of Comparative Example 1 (LCE), Comparative Example 2 (HCE), and Example 1-3 of the present disclosure (LHCE).

### DESCRIPTION OF THE PREFERRED EMBODIMENTS

Herein after, embodiments of the present disclosure will be described in detail with reference to the accompanying drawings in such a manner that the ordinarily skilled in the art can easily implement the embodiments of the present disclosure.

The description given below is not intended to limit the present disclosure to specific Examples. In relation to describing the present disclosure, when the detailed description of the relevant known technology is determined to unnecessarily obscure the gist of the present disclosure, the detailed description may be omitted.

The terminology used herein is for the purpose of describing particular examples only and is not intended to limit the scope of the present disclosure. As used herein, the singular forms “a”, “an”, and “the” are intended to comprise the plural forms as well unless the context clearly indicates otherwise. It will be further understood that the terms “comprise” or “have” when used in the present disclosure specify the presence of stated features, integers, steps, operations, elements and/or combinations thereof, but do not preclude the presence or addition of one or more other features, integers, steps, operations, elements, and/or combinations thereof.

Terms comprising ordinal numbers used in the specification, “first”, “second”, etc. can be used to discriminate one component from another component, but the order or priority of the components is not limited by the terms unless specifically stated. These terms are used only for the purpose of distinguishing a component from another component. For example, without departing from the scope of the present disclosure, a first component may be referred as a second component, and a second component may be also referred to as a first component.

In addition, when it is mentioned that a component is “formed” or “stacked” on another component, it should be understood such that one component may be directly attached to or directly stacked on the front surface or one surface of the other component, or an additional component may be disposed between them.

Hereinafter, the embodiment of the present disclosure shall be explained with reference to the attached drawing, and in describing it by reference to the accompanying drawing, the same or corresponding components shall be given the same figure number and the duplicate description thereof shall be omitted.

An electrolyte comprising solvent with low polarity and method of preparing electrochemical lithium-mediated ammonia using the same will be described in detail. However, those are described as examples, and the present disclosure is not limited thereto and is only defined by the scope of the appended claims.

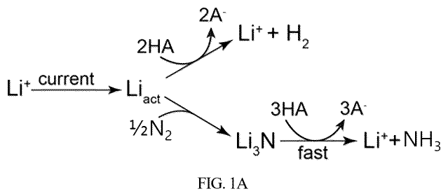

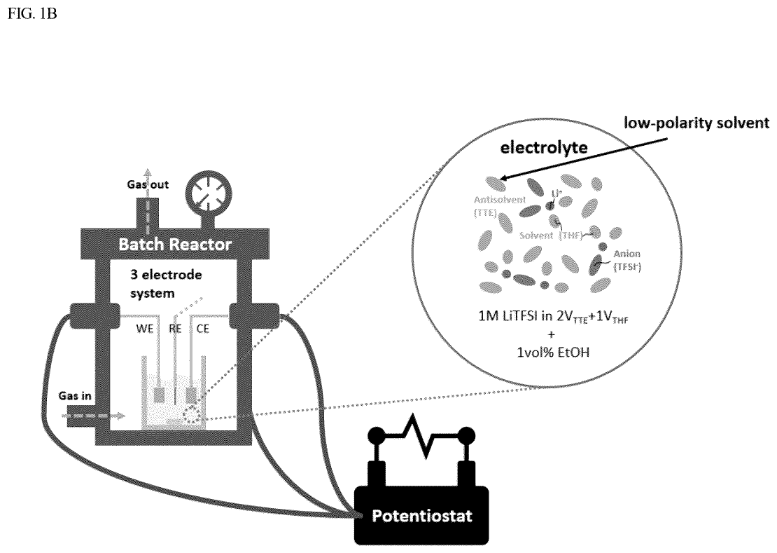

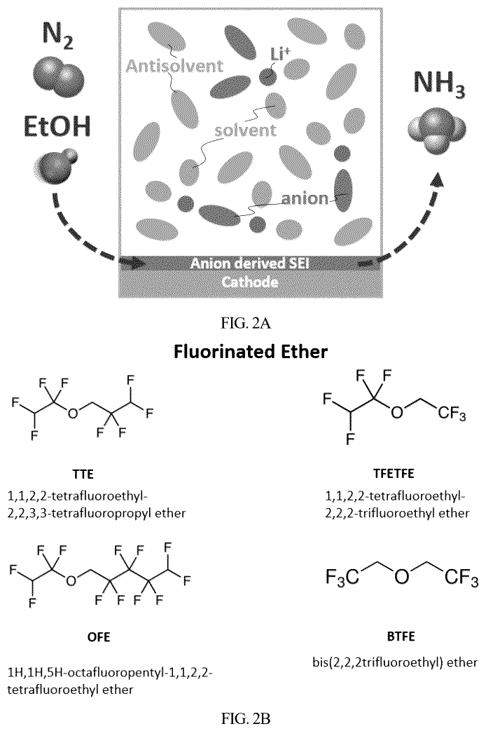

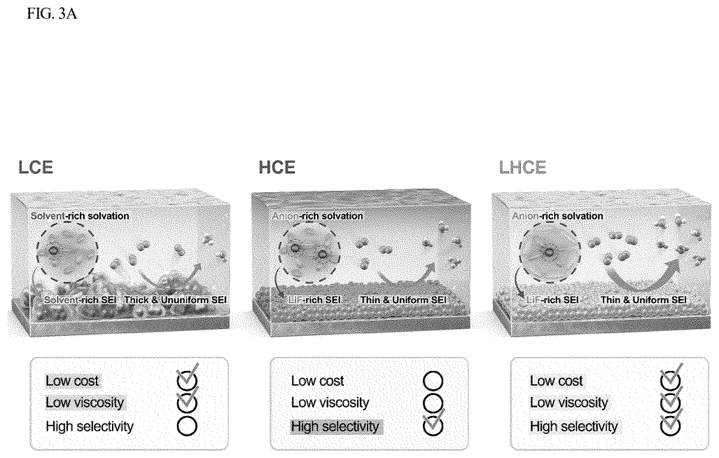

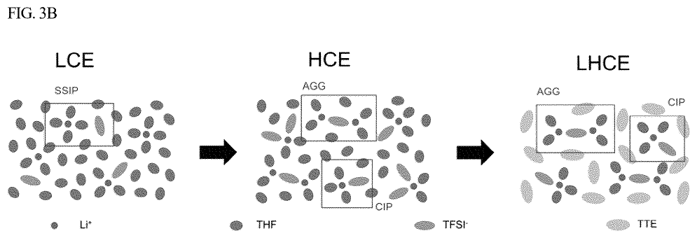

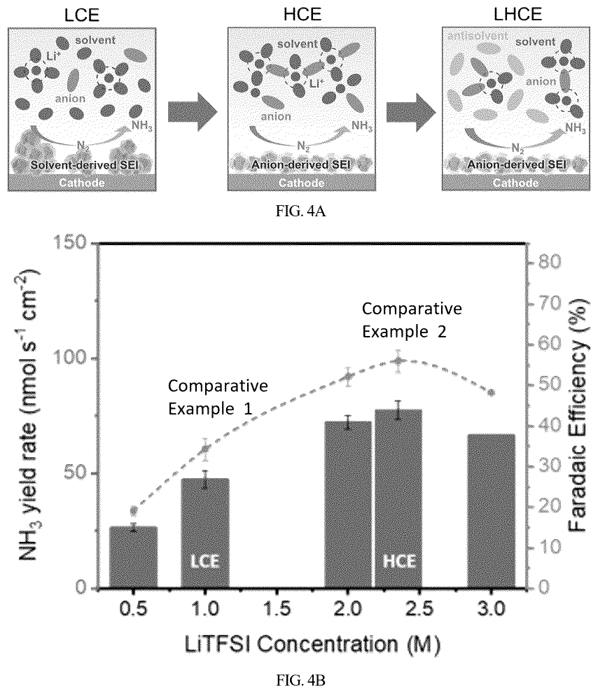

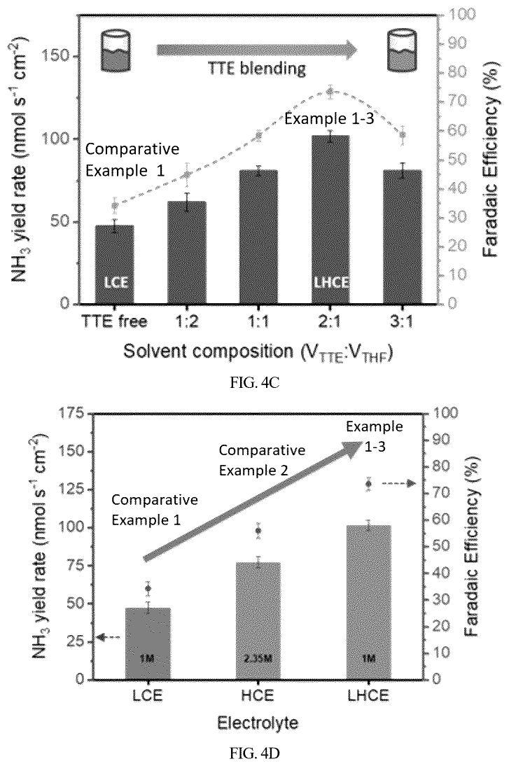

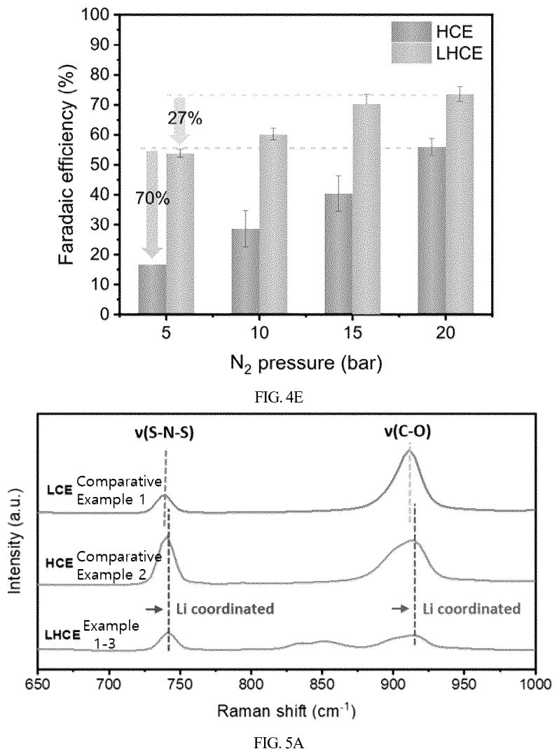

FIG. 1B shows the Li-NRR system of the present disclosure and the electrolyte composition of the present disclosure, FIG. 2A shows a comparison of a local high-concentration electrolyte (LHCE) containing a hydrofluoroether antisolvent of the present disclosure, FIG. 2B shows a Fluorinated Ether that can be used as a second solvent (antisolvent) of the present disclosure, FIG. 3A shows a schematic diagram of the Li-NRR system of each electrolyte of Comparative Example 1 (LCE), Comparative Example 2 (HCE), and Example of the present disclosure (LHCE), FIG. 3B shows a solvent structure showing the ion pair of each electrolyte (LCE, HCE, LHCE) and FIG. 4A shows a schematic diagram of Comparative Example 1 (low concentration electrolyte (LCE)), Comparative Example 2 (high concentration electrolyte (HCE)), and Example of the present disclosure (local high concentration electrolyte (LHCE)).

Referring to FIGS. 1B to 4A, the present disclosure provides an electrolyte comprising a first solvent represented by Structural Formula 1 below; a second solvent represented by Structural Formula 2 below; and a metal salt; and a proton donor compound,

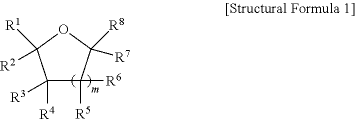

wherein R¹ to R⁸ are identical to or different from each other, and R¹ to R⁸ are each independently a hydrogen atom or a C₁-C₃ alkyl group, m is 1 or 2,

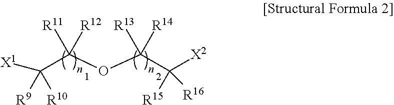

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, R¹ to R⁸ are identical to or different from each other, and R¹ to R⁸ are each independently a hydrogen atom or a methyl group, m is 1 or 2, X¹ is F, R⁹ and R¹⁰ are identical to or different from each other, and R⁹ and R¹⁰ are each independently a hydrogen atom or F, R¹¹ and R¹² are identical to or different from each other, and R¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 5, and n₂ is any integer from 0 to 5.

In addition, R¹ to R⁸ are each a hydrogen atom, m is 1, X¹ is F, R⁹ and R¹⁰ are identical to or different from each other, and R⁹ and R¹⁰ are each independently a hydrogen atom or F, R¹¹ and R¹² are identical to or different from each other, and R¹¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 3, and n₂ is any integer from 0 to 3.

In addition, the electrolyte may be used in an electrochemical ammonia production system.

In addition, the electrolyte may comprise: 100 parts by weight of the first solvent represented by the Structural Formula 1; 100 to 400 parts by weight of the second solvent represented by the Structural Formula 2; 50 to 250 parts by weight of the lithium salt; and 1 to 10 parts by weight of the proton donor compound.

In addition, a volume ratio of the second solvent and the first solvent may be 0.1:1 to 9:1, preferably 0.5:1 to 5:1, more preferably 1:1 to 3:1. When the volume ratio of the second solvent and the first solvent is less than 0.1:1, it is insufficient to control the solvation structure, which is undesirable. When it is higher than 9:1, the operating voltage required increases as the conductivity of the electrolyte decreases, which is undesirable.

In addition, a concentration of the metal salt may be 0.5 to 5 M based on a total of the first solvent and the second solvent.

In addition, a dielectric constant of the second solvent may be smaller than that of the first solvent, and a dipole moment of the second solvent may be smaller than that of the first solvent.

In addition, it is preferable that the second solvent has a low donor number (<10) for the antisolvent, is highly fluorinated to have high electrochemical stability and low polarity, and has a bulky structure as a chain type ether to maximize the antisolvent effect and be miscible with THF.

Also, referring to FIG. 2B, the second solvent may be at least one selected from the group consisting of Fluorinated Ether, preferably 1,1,2,2-tetrafluoroethyl-2,2,3,3-tetrafluoropropyl ether (TTE), 1,1,2,2-tetrafluoroethyl-2,2,2-trifluoroethylether (TFETFE), 1H,1H,5H-octafluoropentyl-1,1,2,2-tetrafluoroethyl ether (OFE) and bis(2,2,2-trifluoroethyl) ether (BTFE).

In addition, the second solvent may interfere with solvation of a metal ion of the metal salt.

In addition, the number of ion pairs of metal ions and anions in the solution may increase by the second solvent.

In addition, an anion-derived solid electrolyte interphase (SEI) can be generated when the ion pairs are first reduced. This is because the material participating in solvation has a characteristic of preferentially reducing.

Referring to FIG. 1B, LiF, as a representative inorganic and electron insulating material, enables thin and uniform Li plating and prevents additional side reactions. Since the antisolvent is a solvent that cannot solvate Li and cannot be used alone as an electrolyte, it was used in a mixed form with the conventional solvent THF. The antisolvent replaces the THF site and exists on the outside of the Li solvation shell, and accordingly, instead of THF with the reduced amount, the anion (TFSI⁻) can form an anion rich solvation structure by further combining with Li. In other words, an anion rich solvation similar to a high concentration can be formed even while using a small amount of Li salt.

In addition, the side reaction in which the solvent and electrolyte are decomposed can be reduced by the anion-derived solid electrolyte interphase (SEI).

In addition, the Faradaic Efficiency (FE) can be improved by controlling the metal ion diffusivity and increasing the selectivity through the anion-derived SEI.

In addition, the anion-derived SEI may contain a higher proportion of inorganic compounds than organic compounds.

In addition, the metal salt may comprise at least one selected from the group consisting of a lithium salt, a zinc salt, a sodium salt, a nickel salt, a calcium salt, and a magnesium salt.

In addition, the lithium salt may comprise at least one selected from the group consisting of lithium bisfluorosulfonylimide (Li(FSO₂)₂N), LiFSI), lithium hexafluorophosphate (LiPF₆), lithium tetrafluoroborate (LiBF₄), lithium perchlorate (LiClO₄), lithium trifluoromethanesulfonylimide (LiN(CF₃SO₂)₂, LiTFSI), lithium triflate (LiCF₃SO₃), lithium difluoro(bis(oxalato))phosphate (LiPF₂(C₂O₄)₂), lithium tetrafluoro(oxalato)phosphate (LiPF₄(C₂O₄)), lithium difluoro(oxalato)borate (LiBF₂(C₂O₄)), and lithium bis(oxalato)borate (LiB(C₂O₄)₂).

In addition, the proton donor compound may comprise at least one selected from the group consisting of ethanol, methanol, isopropanol, n-propanol, n-butanol, glycol, propylene glycol, glycerol, butane diol, ammonia, formic acid, acetic acid, and water.

Another aspect of the present disclosure provides an ammonia production system comprising a working electrode, a counter electrode, a reference electrode, and an electrolyte, wherein the electrolyte comprises: a first solvent represented by Structural Formula 1 below; a second solvent represented by Structural Formula 2 below; a metal salt; and a proton donor compound,

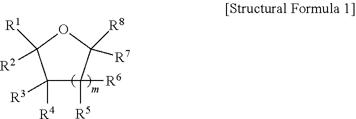

wherein R¹ to R⁸ are identical to or different from each other, and R¹ to R⁸ are each independently a hydrogen atom or a C₁-C₃ alkyl group, m is 1 or 2,

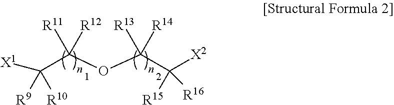

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, R¹ to R⁸ are identical to or different from each other, and R¹ to R⁸ are each independently a hydrogen atom or a methyl group, m is 1 or 2, X¹ is F, R⁹ and R¹⁰ are identical to or different from each other, and R⁹ and R¹⁰ are each independently a hydrogen atom or F, R¹¹ and R¹² are identical to or different from each other, and R¹ and R¹² are each independently a hydrogen atom or F, R¹³ and R¹⁴ are identical to or different from each other, and R¹³ and R¹⁴ are each independently a hydrogen atom or F, X² is F, R¹⁵ and R¹⁶ are identical to or different from each other, and R¹⁵ and R¹⁶ are each independently a hydrogen atom or F, n₁ is any integer from 0 to 5, and n₂ is any integer from 0 to 5.

In addition, an ammonia may be produced at the working electrode and a hydrogen may be produced at the counter electrode.

In addition, the working electrode may comprise a nickel atom, the counter electrode may comprise a platinum atom, and the reference electrode comprises a platinum atom.

FIG. 1A shows the reaction mechanism of Li-NRR (lithium mediated nitrogen reduction) of the present disclosure.

Referring to FIG. 1A, the present disclosure provides a method of producing an ammonia, the method comprising: (a) supplying an ammonia production system; and (b) supplying a nitrogen to the ammonia production system to perform a reduction reaction, thereby producing an ammonia, wherein the system comprises a working electrode, a counter electrode, a reference electrode, and an electrolyte, wherein the electrolyte comprises: a first solvent represented by Structural Formula 1 below; a second solvent represented by Structural Formula 2 below; a metal salt; and a proton donor compound,

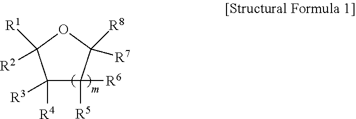

wherein R¹ to R⁸ are identical to or different from each other, and R¹ to R⁸ are each independently a hydrogen atom or a C₁-C₃ alkyl group, m is 1 or 2,

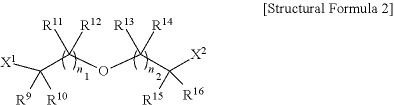

X¹ is F, Cl, Br or I, R⁹ and R¹⁰ are identical to or different from each other, and R⁹ and R¹ are each independently a hydrogen atom, F, Cl, Br or I, R¹¹ and R¹² are identical to or different from each other, and R¹¹ and R¹² are each independently a hydrogen atom, F, Cl, Br or I, R¹³ and R¹⁴ are identical to or different from each other, and R¹³ and R¹⁴ are each independently a hydrogen atom, F, Cl, Br or I, X² is F, Cl, Br or I, R¹⁵ and R¹⁶ are identical to or different from each other, and R¹⁵ and R¹⁶ are each independently a hydrogen atom, F, Cl, Br or I, n₁ is any integer from 0 to 7, and n₂ is any integer from 0 to 7.

In addition, the reduction reaction may be carried out by lithium-mediated nitrogen reduction (Li-NRR).

In addition, a nitrogen may be supplied at a pressure of 5 to 25 bar.

In addition, because of the low polarity of the second solvent, the solvation of the metal ion of the metal salt may be interfered with.

In addition, because of the low polarity of the second solvent, the distance between the solvent and the metal ion may increase, and as the space between them is filled with anions, the number of ion pairs of the metal ion and the anion in the solution may increase.

In addition, as the distance between the solvent and the metal ion increases, the side reaction in which the solvent and the electrolyte are decomposed may decrease.

In addition, as the distance between the solvent and the metal ion increases, an anion-derived Solid Electrolyte Interphase (SEI) may be generated due to an increase in the content of anions.

In addition, the anion-derived SEI may contain a higher proportion of inorganic compounds than organic compounds.

In addition, the Faradaic Efficiency (FE) can be improved by controlling the metal ion diffusivity and increasing the selectivity by the anion-derived SEI.

In addition, the metal ion can be uniformly deposited by including the electrolyte.

In addition, when the ammonia production system is operated, the current density can be 30 to 50 mAcm⁻².

Ammonia is a compound that has been attracting attention as a hydrogen carrier in existing fertilizers.

Up to now, the ammonia has been produced at high temperature and high pressure according to the Haber-Bosch method, so the carbon emissions are significant. Therefore, the inventors of the present disclosure are producing electrochemical ammonia by nitrogen reduction using lithium, which is called lithium mediated nitrogen reduction reaction (Li-NRR). The simple mechanism is that lithium is first deposited, and after nitrogen is chemisorbed, lithium nitride is formed. At this time, when the proton donor provides protons, lithium nitride is reduced to form ammonia, and lithium returns to the ion form.

At this time, the index related to the efficiency of ammonia production is Faradaic Efficiency (FE), which is the ratio of charge consumed for ammonia production per total charge flowed. It has been reported that two factors can affect the increase of FE. First, lithium diffusion changes due to the components of SEI, which is a membrane in which the electrolyte is decomposed on the electrode, and the second is that side reactions such as electrolyte decomposition are reduced. The inventors of the present disclosure conducted a study to modify the electrolyte to increase FE.

In addition, the inventors attempted to increase FE, which is the ammonia production efficiency, by engineering the solvent that is fixedly used in Li-NRR. First, when a solvent with a low donor number is used in the existing battery field, the solvation of lithium and the solvent changes. Even in the battery field and the Li-NRR field, when this solvent with a low donor number is used, lithium and anions are relatively strongly bound, and the content of anions in the solvation shell increases. Like this, when an electrolyte with increased anion-rich solvation is used, selectivity and SEI modification can be affected.

The present disclosure relates to increasing electrochemical ammonia productivity through the introduction of a second solvent and electrolyte control. And electrolyte control was confirmed by introducing the field of green ammonia production and a solvent with low polarity. High efficiency could be obtained even when a salt that shows high production efficiency in a high-concentration electrolyte was used at a low concentration. By blending the existing solvent and the solvent with low polarity, the decrease in conductivity was minimized and not only productivity but also energy efficiency was improved.

Through green ammonia production process in a low-temperature and low-pressure environment, ammonia can be used as a means of transporting hydrogen as the demand for hydrogen increases in the steel and chemical industries. The ammonia in itself is also an eco-friendly fuel that can be used in ships and automobiles.

The ammonia production by existing Haber-Bosch method was carried out through the catalytic reaction of hydrogen and nitrogen under conditions of pressures of 200 atm or higher and high temperatures of 400° C. or higher. This method consumes a lot of energy and emits an excessive amount of carbon, accounting for 1.8% of global carbon dioxide emissions.

The introduction of the second solvent with low polarity of the present disclosure can control the dissolution structure in the electrolyte. This solvation structure can control the stability of the system and the composition of the electrolyte decomposition membrane, thereby improving the performance of the system. Therefore, an electrochemical ammonia production system that can be operated in a room-temperature and low-pressure environment was manufactured.

### EXAMPLES

Hereinafter, the examples of the present disclosure will be described. However, the examples are for illustrative purposes, and the scope of the present disclosure is not limited by the examples.

### Example 1: Electrochemical Reaction of LHCE (1M LiTFSI in V_{TTE}+V_{THF} Electrolyte)

### Example 1-1: V_{TTE}:V_{THF}=1:2 (vol:vol)

FIG. 1B shows the Li-NRR system of the present disclosure and the electrolyte composition of the present disclosure.

Referring to FIG. 1B, an electrochemical reaction is induced in a batch type reactor. Nickel foil, Pt foil and Pt wire were used as the working electrode, counter, and reference electrode, respectively, and a fixed current density of 40 mA/cm² was applied, and nitrogen was pressurized to an excess of 20 atm to cause an electrochemical reaction.

LiTFSI 2.871 g was dissolved to have a concentration of 1 M LiTFSI, and a solution having a cosolvent of tetrahydrofuran (THF) and TTE (1,1,2,2-tetrafluoroethyl-2,2,3,3-tetrafluoropropyl ether) in a volume ratio of 2:1 was prepared. An electrolyte was prepared by making the solution 1 vol % of ethanol, a proton donor.

Table 1 below is the input amounts of raw materials of Example 1 of the present disclosure.

TABLE 1

| | 1M LiTFSI/TTE | | input amount | |
|---|---|---|---|---|
| Lithium salt(LiTFSI) | | | 2.871 | g |
| | cosolvent | TTE | 3 | ml |
| | | THF | 6 | ml |
| | proton donor | ethanol | 0.1 | ml |

### Example 1-2: TTE:THF Volume Ratio=1:1

The electrochemical reaction was performed in the same manner as in Example 1-1, except that a cosolvent mixed at a ratio of 1:1 by mixing 4.5 mL of TTE and 4.5 mL of THF was used as a solvent.

### Example 1-3: TTE:THF Volume Ratio=2:1

The electrochemical reaction was performed in the same manner as in Example 1-1, except that a cosolvent mixed at a ratio of 2:1 by mixing 6 mL of TTE and 3 mL of THF was used as a solvent.

### Example 1-4: TTE:THF Volume Ratio=3:1

The electrochemical reaction was performed in the same manner as in Example 1-1, except that a cosolvent mixed at a ratio of 3:1 by mixing 6.7 mL of TTE and 2.3 mL of THF was used as a solvent.

### Example 2: Electrochemical Reaction in TFETFE Electrolyte

### Examples 2-1 to 2-4

The electrochemical reaction was performed in the same manner as in Examples 1-1 to 1-4, respectively, except that TFETFE (1,1,2,2-tetrafluoroethyl-2,2,2-trifluoroethyl ether) was used instead of TTE.

### Comparative Example: Electrolyte without Mixing Solvent with Low Polarity

### Comparative Example 1: 1 M LiTFSI in THF (LCE)

The electrochemical reaction was performed in the same manner as in Example 1-1, except that only THF was used instead of TTE and THF.

### Comparative Example 2: 2.35 M LiTFSI in THF (HCE)

The electrochemical reaction was performed in the same manner as in Example 1-1, except that only THF was used instead of TTE and THF, and that 2.35 M lithium TFSI salt (LiTFSI) solution was used instead of 1 M lithium TFSI salt (LiTFSI) solution.

### Comparative Example 3: 3M LiTFSI in THF (HCE)

The electrochemical reaction was performed in the same manner as in Example 1-1, except that only THF was used instead of TTE and THF, and 3M lithium TFSI salt (LiTFSI) solution was used instead of 1M lithium TFSI salt (LiTFSI) solution.

### Comparative Example 4: 1M LiTFSI in Anisole and THF (LHCE 2)

The electrochemical reaction was performed in the same manner as in Example 1-3, except that Anisole was used instead of TTE.

### Comparative Example 5: 1M LiTFSI in Furan and THF (LHCE 3)

The electrochemical reaction was performed in the same manner as in Example 1-3, except that Furan was used instead of TTE.

### Comparative Example 6: 1M LiTFSI in mFT and THF (LHCE 4)

The electrochemical reaction was performed in the same manner as in Example 1-3, except that mFT (m-fluorotoluene) was used instead of TTE.

Table 2 below summarizes the conditions of Examples 1-1 to and 2-4 and Comparative Examples 1 to 6.

TABLE 2

| | Lithium salt | | First solvent:Second |
|---|---|---|---|
| | (LiTFSI) | Electrolyte | solvent |
| | Concentration | component | (volume ratio) |
| Example 1-1 | 1M | TTE:THF | 1:2 |
| Example 1-2 | 1M | TTE:THF | 1:1 |
| Example 1-3 | 1M | TTE:THF | 2:1 |
| Example 1-4 | 1M | TTE:THF | 3:1 |
| Example 2-1 | 1M | TFETFE:THF | 1:2 |
| Example 2-2 | 1M | TFETFE:THF | 1:1 |
| Example 2-3 | 1M | TFETFE:THF | 2:1 |
| Example 2-4 | 1M | TFETFE:THF | 3:1 |
| Comparative | 1M | THF | — |
| Example 1 | | | |
| Comparative | 2.35M | THF | — |
| Example 2 | | | |
| Comparative | 3M | THF | — |
| Example 3 | | | |
| Comparative | 1M | Anisole:THF | 2:1 |
| Example 4 | | | |
| Comparative | 1M | Furan:THF | 2:1 |
| Example 5 | | | |
| Comparative | 1M | mFT:THF | 2:1 |
| Example 6 | | | |

### Test Example

### Test Example 1: Electrochemical Analysis

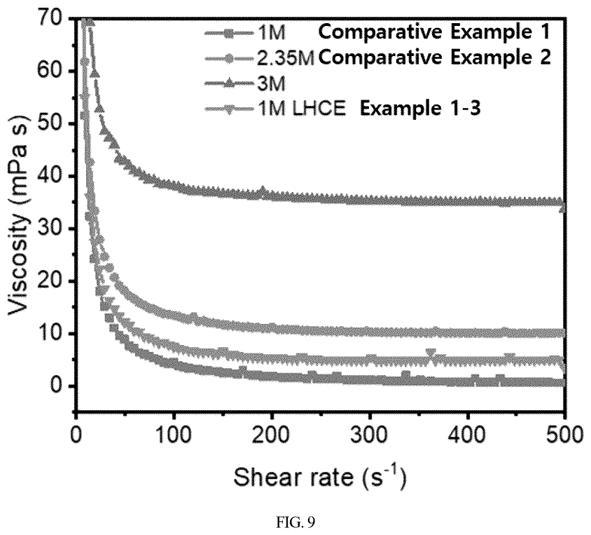

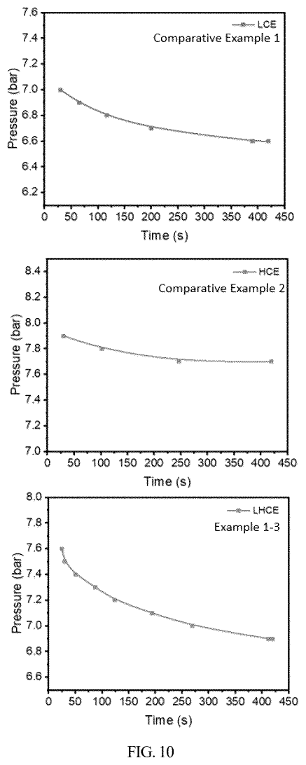

FIG. 4A shows a schematic diagram of Comparative Example 1 (low concentration electrolyte (LCE)), Comparative Example 2 (high concentration electrolyte (HCE)), and Example 1-3 of the present disclosure (local high concentration electrolyte (LHCE)), FIG. 4B shows ammonia yields and faradaic efficiencies at various LiTFSI concentrations at 20 bar N₂ and a current density of −40 mA/cm², FIG. 4C shows ammonia yields and faradaic efficiencies at various solvent compositions at 1 M LiTFSI, 20 bar N₂, and a current density of −40 mA/cm², FIG. 4D shows a comparison of ammonia yields and faradaic efficiencies between Comparative Example 1 (LCE), Comparative Example 2 (HCE), and Example 1-3 of the present disclosure (LHCE), FIG. 4E is a schematic diagram of the dependence of the Faraday efficiency on the N₂ pressure of Comparative Example 2 (HCE) and Example 1-3 of the present disclosure (LHCE), FIG. 9 shows the measured viscosity data of each electrolyte of Comparative Example 1 (1M, LCE in the present disclosure), Comparative Example 2 (2.35M, HCE in the present disclosure), Comparative Example 3 (3M), and Example 1-3 of the present disclosure (1M LHCE) and FIG. 10 shows the results of measuring the N₂ solubility of each electrolyte (LCE, HCE, LHCE) of Comparative Example 1, Comparative Example 2, and Example 1-3 of the present disclosure.

Referring to FIG. 4A, LCE (1M LiTFSI in THF) forms a solvent-derived SEI because the solvent is predominantly present around Li⁺, HCE (2.35M LiTFSI in THF) forms anion-derived SEI because more anions are present around Li⁺ than LCE, and LHCE (1M LiTFSI in 2V_{TTE}+1V_{THF}) maintains the anion-rich solvation structure of HCE and forms anion-derived SEI by introducing an antisolvent that cannot solvate Li⁺.

Referring to FIG. 4B, it shows the yield and FE correlation according to the concentration of LiTFSI, which is a Li salt. It was confirmed that FE increases at the beginning and then decreases at too high a concentration (>3M). This is because the viscosity is high and mass transfer is limited.

Referring to FIG. 4C, when the composition of the solvent was changed using TTE, which is an antisolvent, the change in FE was shown, and the maximum FE was observed at a ratio of V_{TTE}:V_{THF}=2:1.

Referring to FIG. 4D, the ammonia yield and FE patterns of LCE, HCE, which are comparative examples 1 and 2, and LHCE, which is an exemplary embodiment of the present disclosure, were shown, with LCE: 34.3%, HCE: 56.0%, and LHCE: 73.6%, showing that LHCE had the highest FE.

Referring to FIGS. 4E, 9, and 10, the FE change experiment according to nitrogen pressure was shown in HCE and LHCE, and the amount of ammonia decreased in LHCE was smaller than in HCE as the nitrogen pressure was lowered. In other words, it was confirmed that high FE could be achieved even with low nitrogen pressure. This is likely due to the characteristics of TTE, which is lower in viscosity and lower in polarity than HCE.

### Test Example 2: Electrolyte Analysis Before Reaction

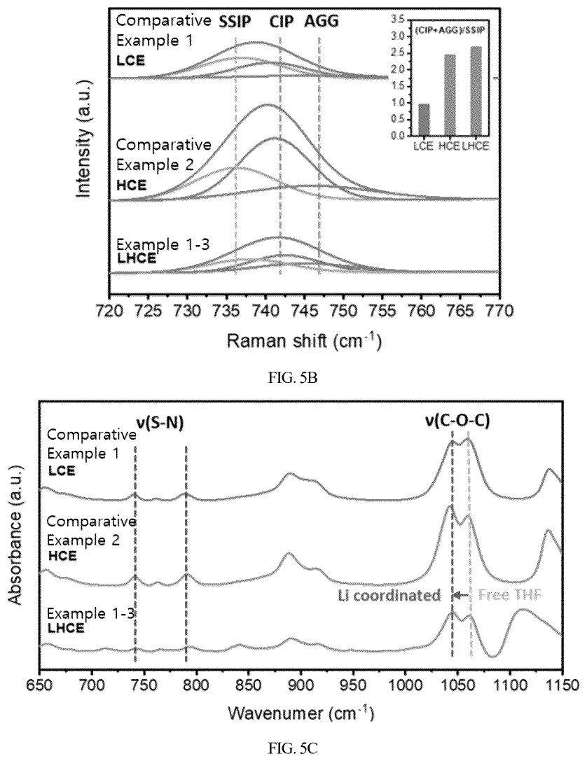

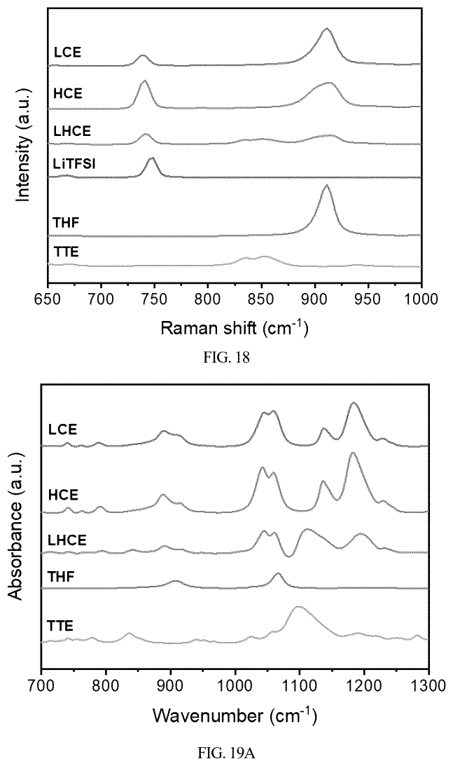

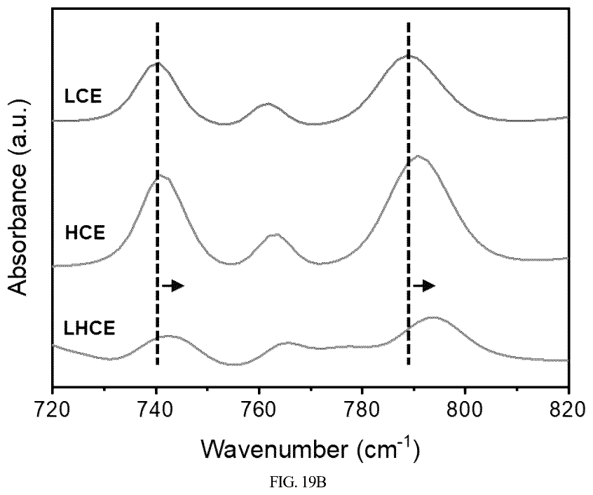

FIG. 5A is the Raman spectrum result of each electrolyte, FIG. 5B is the S—N—S bending region (720˜760 cm⁻¹) result of the Raman spectrum of each electrolyte, FIG. 5C is the FT-IR spectrum result of each electrolyte, FIG. 5D shows a comparison of the ⁷Li-NMR results of each electrolyte, FIG. 18 is the full Raman spectra of Comparative Example 1 (LCE), Comparative Example 2 (HCE), Example 1-3 of the present disclosure (LHCE), lithium bis(fluorosulfonyl)imide (LiTFSI), tetrahydrofuran (THF), and Example of the present disclosure (1,1,2,2-tetrafluoroethyl-2,2,3,3-tetrafluoropropyl ether, TTE), FIG. 19A is the full FT-IR spectra of Comparative Example 1 (LCE), Comparative Example 2 (HCE), Example 1-3 of the present disclosure (LHCE), tetrahydrofuran (THF), and 1,1,2,2-tetrafluoroethyl-2,2,3,3-tetrafluoropropyl ether (TTE) and FIG. 19B is the S—N vibration region of the FT-IR spectrum of each electrolyte of Comparative Example 1 (LCE), Comparative Example 2 (HCE), and Example 1-3 of the present disclosure (LHCE).

Referring to FIG. 5, 740 cm⁻¹: S—N—S bending, 913 cm⁻¹: C—O stretching, 1066 cm⁻¹: C—O—C ring stretch (asymmetric), 910 cm⁻¹: C—O (symmetric), 740, 780 cm⁻¹: S—N stretching were confirmed.

In addition, Raman and FT-IR analyses were performed to confirm whether CIP, AGG-rich (anion rich) solvation was generated.

Referring to FIG. 5A, the coordination of Li and TFSI increased through the right shift of the S—N—S peak near 748 cm⁻¹ toward LHCE, and the coordination of Li and THF increased through the right shift of the C—O peak near 910 cm⁻¹. This is because the anion is more coordinated when looking at the solvation shell itself, but from the THF perspective, most of the THF is coordinated with Li, so free THF was confirmed to decrease. It can be seen that the decrease in free THF helps to improve oxidative stability.

Referring to FIG. 5B, the composition of each ion pair shows that SSIP decreases and the proportions of CIP and AGG increase in HCE and LHCE, which confirms the formation of anion-rich solvation.

Referring to FIG. 5C, FIG. 18, and FIG. 19, it was confirmed that the S—N peaks appearing at 740 cm⁻¹ and 780 cm⁻¹ were slightly shifted to the right when FT-IR was performed. The THF peak near 1066 cm⁻¹ showed an increase in left shift, which also means a decrease in free THF.

The shifts in the THF peak in Raman and FT-IR showed opposite trends because Raman detects changes in polarizability by observing scattering signals, whereas FT-IR detects changes in dipole moments by observing absorption.

### Test Example 3: Analysis of the Cause of Performance Improvement in HCE and LHCE Compared to LCE (SEM, XPS)

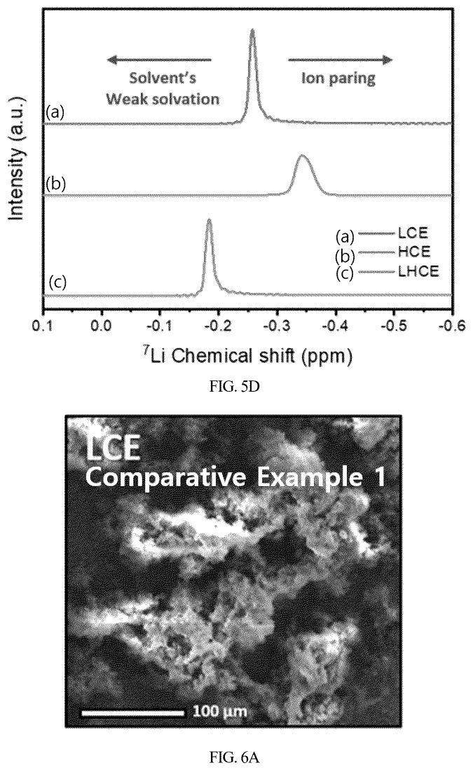

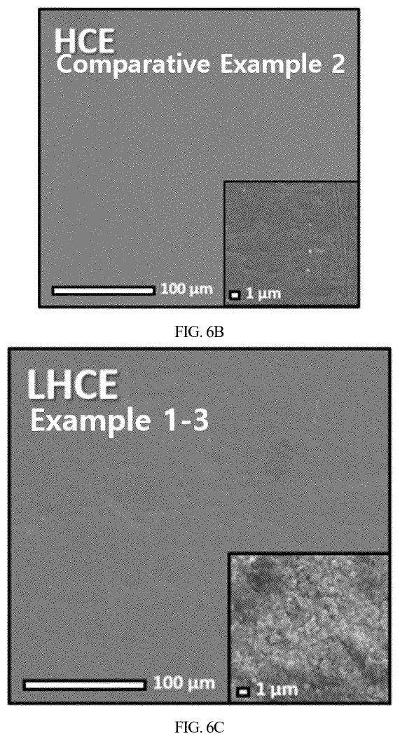

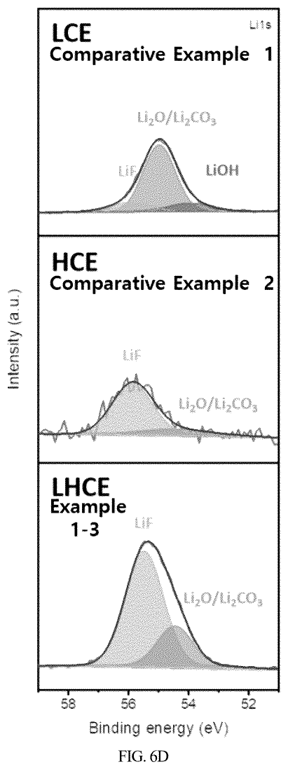

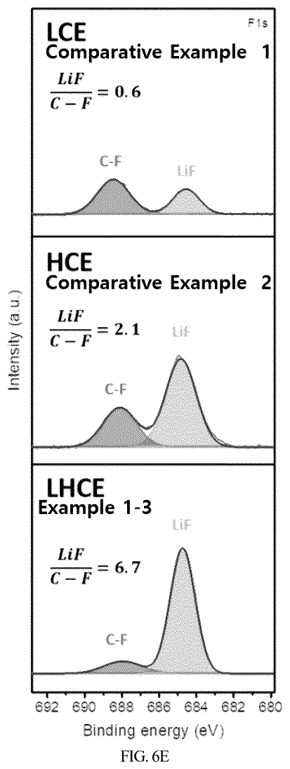

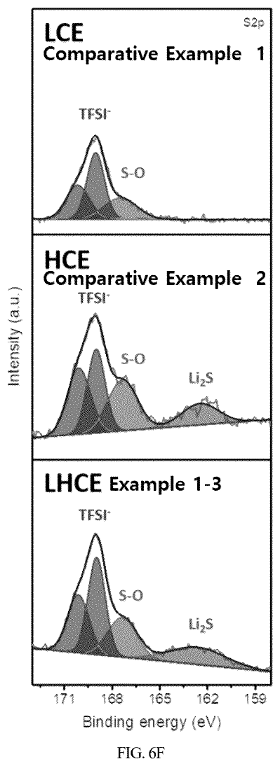

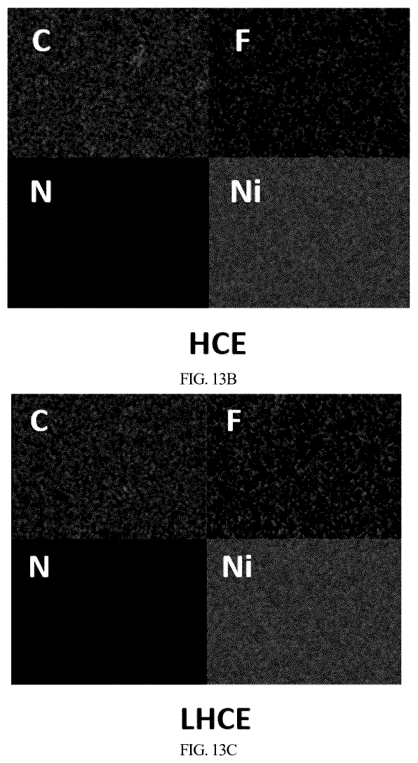

FIGS. 6A to 6C are SEM images of LCE, HCE, and LHCE for SEI after electrochemical reaction, respectively, FIGS. 6D to 6F are XPS spectra of Li 1s, F 1s, and S 2p for SEI in each electrolyte and FIGS. 13A to 13C are SEM-EDS images of SEI in Comparative Example 1 (LCE), Comparative Example 2 (HCE), and Example 1-3 of the present disclosure (LHCE), respectively.

Referring to FIG. 6, the cause of the performance improvement in HCE and LHCE compared to LCE was analyzed through SEM and XPS.

Referring to FIG. 6A and FIG. 13, a thick and non-uniform SEI was observed even at low magnification. Referring to FIG. 13, it appeared that TFSI and C-based byproducts with less decomposition were thickly aggregated.

Referring to FIG. 6B and FIG. 6C, no visible SEI was observed at low magnification, and a thin and rough or porous SEI was observed at high magnification.

Referring to FIG. 6D and FIG. 6E, the ratio of LiF was observed to be higher in Comparative Example 2 (HCE) and Example 1-3 (LHCE) than in Comparative Example 1 (LCE).

Referring to FIG. 6F, Li₂S, an inorganic species, was observed in Comparative Example 2 (HCE) and Example 1 (LHCE). In Comparative Example 1 (LCE), Li₂S was not observed, suggesting that a thick organic layer exists in the upper layer of the SEI.

Through this, it appears that an SEI in which inorganic LiF and Li₂S are more observed was formed in Comparative Example 2 (HCE) and Example 1-3 (LHCE), and it was confirmed that this forms a thin, compact SEI and prevents further electrolyte decomposition. In Example 1-3 (LHCE), where an SEI of a different morphology from Comparative Example 2 (HCE) was formed, it appears that N₂ permeability may be improved.

### Test Example 4: Analysis of the Results of Testing Other Antisolvent Candidates with Low DN in Addition to TTE

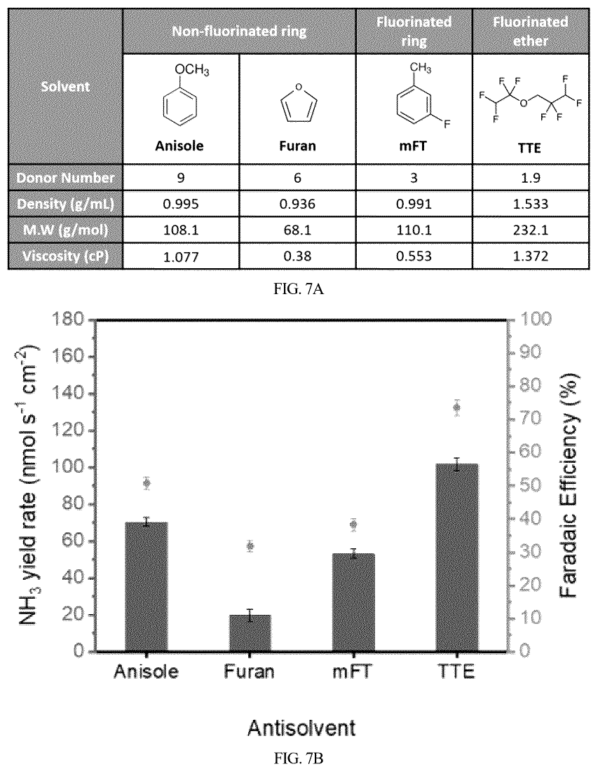

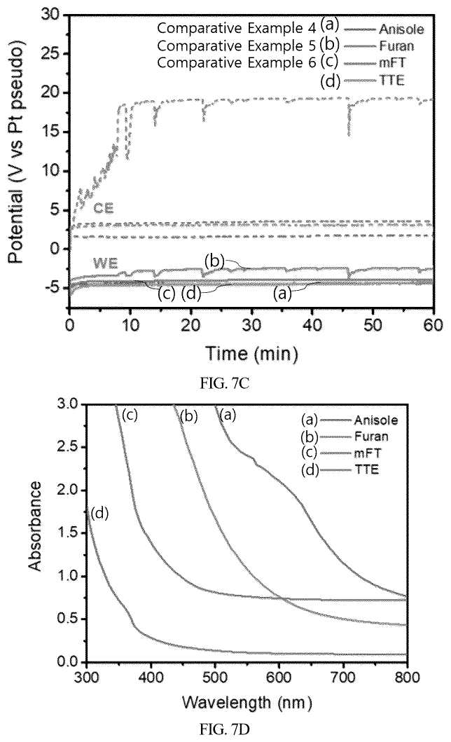

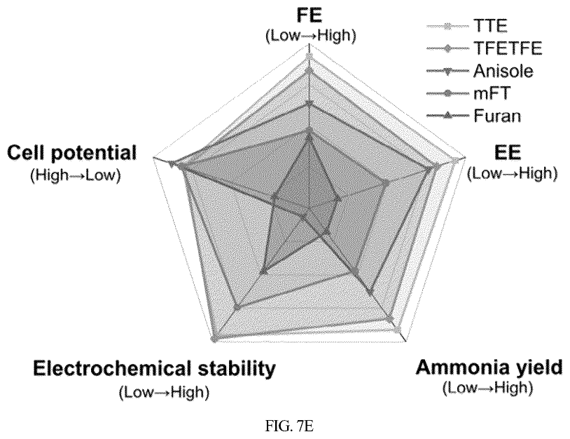

FIG. 7A shows the results of investigating the physical properties of antisolvent of the present disclosure, FIG. 7B shows the ammonia yield and faradaic efficiency of various antisolvent based LHCEs, FIG. 7C shows the potential profiles of various antisolvent based LHCEs, FIG. 7D shows the UV-vis absorbance spectra of various antisolvent based LHCEs after electrochemical reaction and FIG. 7E shows the electrochemical performances of various antisolvent based LHCEs.

Referring to FIG. 7A, it shows the physical property information of the antisolvent, and referring to FIG. 7B, it can be seen that Example (TTE) of the present disclosure showed the highest efficiency in the FE graph.

Referring to FIG. 7C, the very low oxidative stability of Furan (Comparative Example 5) and the low CE potential of Anisole (Comparative Example 4) in the potential profile seemed to be due to the low oxidative stability of anisole itself, which was oxidized first instead of THF. Through this, it was confirmed that Furan (Comparative Example 5) and Anisole (Comparative Example 4) had poor electrochemical stability.

Referring to FIG. 7D, the color of the solution was observed after the reaction, and Example (TTE) of the present disclosure showed the lightest color and the highest electrochemical stability. Through this, it was confirmed that it could enable continuous stable cycling of Li-NRR.

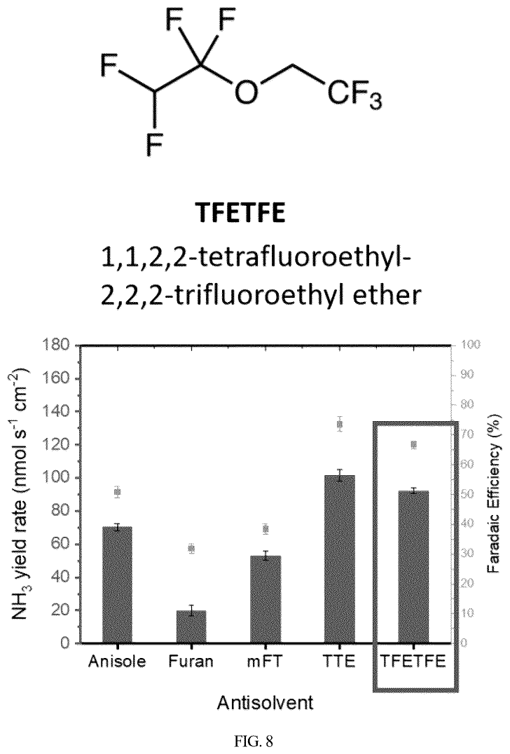

Referring to FIG. 7E and FIG. 8, the performance when each antisolvent was used was shown, and it was confirmed that Example (TTE) of the present disclosure showed the best performance.

### Test Example 5: Electrochemical Impedance Spectroscopy (EIS) Analysis of Each Electrolyte Before Reaction

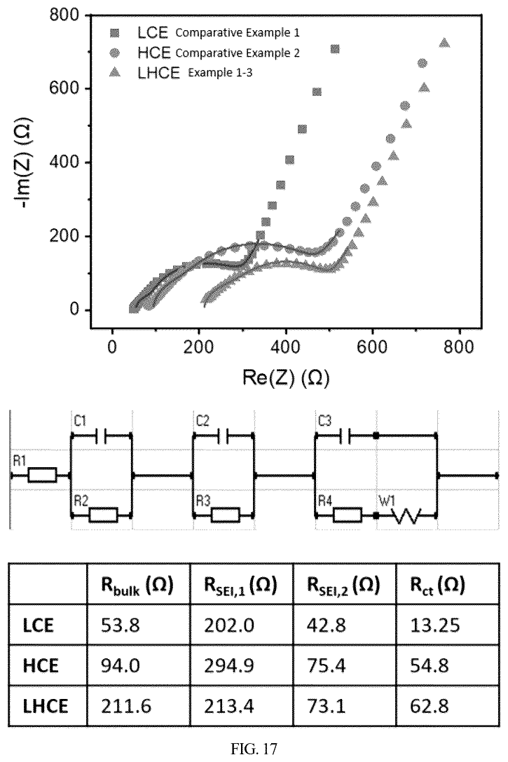

FIG. 17 is electrochemical impedance spectroscopy (EIS) data of each electrolyte of Comparative Example 1 (LCE), Comparative Example 2 (HCE), and Example 1-3 of the present disclosure (LHCE) before reaction.

Referring to FIG. 17, it was confirmed that the bulk resistance of LHCE itself was large, which was due to the low conductivity of the antisolvent TTE and the increase in CIP and AGG.

### Test Example 6: Confirmation of Ammonia Yield

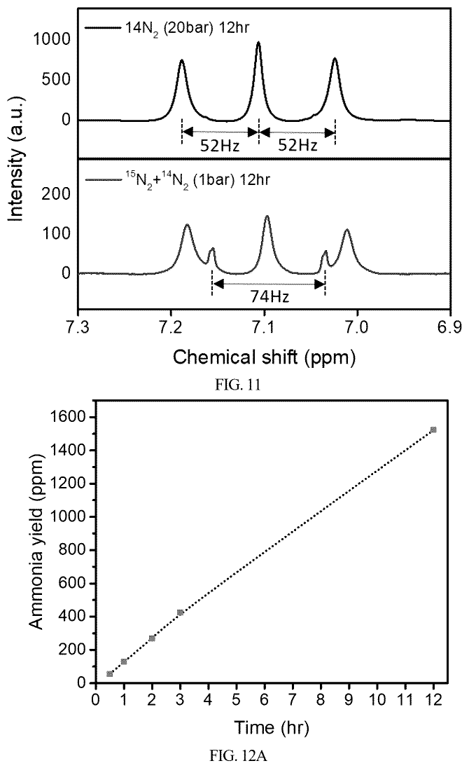

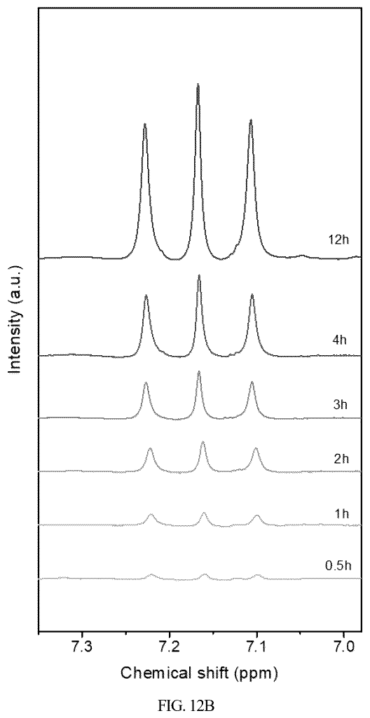

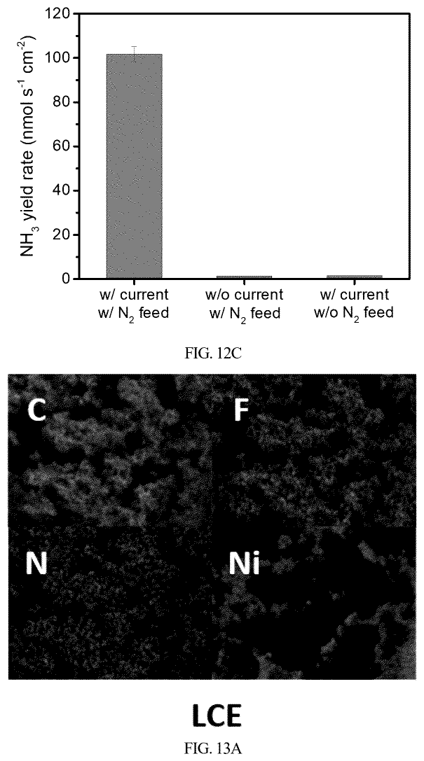

FIG. 11 shows that ammonia production occurs in N₂ gas with isotope test of ¹⁵N₂:¹⁴N₂=1:5 ratio, FIG. 12A shows the ammonia yield dependence over time showing a linear relationship up to 12 hours, FIG. 12B shows the ammonia yield at various reaction times confirmed by ¹H NMR and FIG. 12C shows a control experiment controlling current and N₂ supply.

Referring to FIGS. 11 and 12, it was confirmed that the ammonia detected in the reaction system was not an impurity but a material synthesized from the present disclosure.

### Test Example 7: Analysis after 1-Hour Electrochemical Reaction

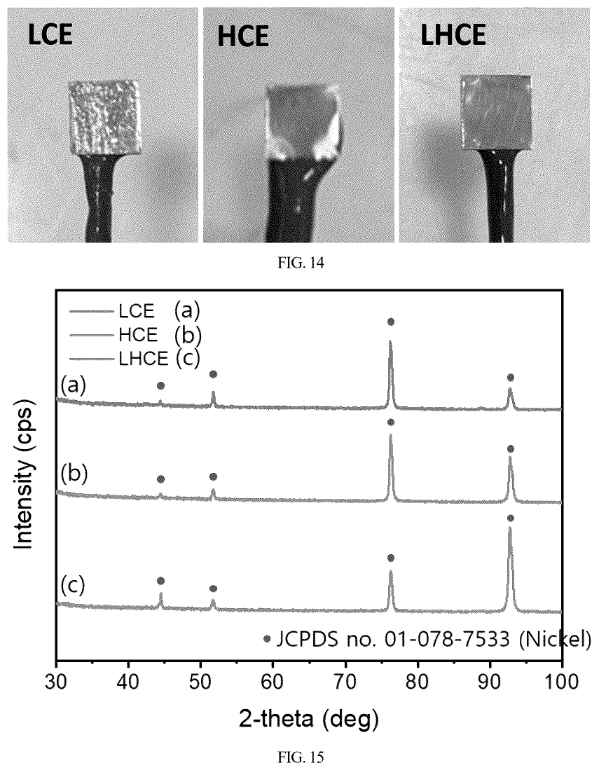

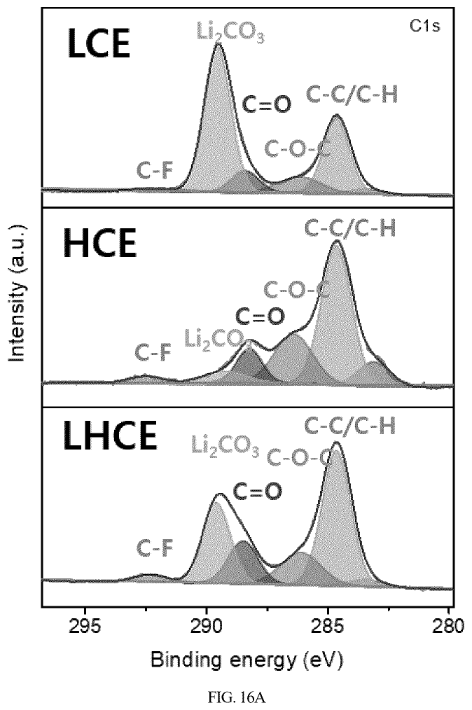

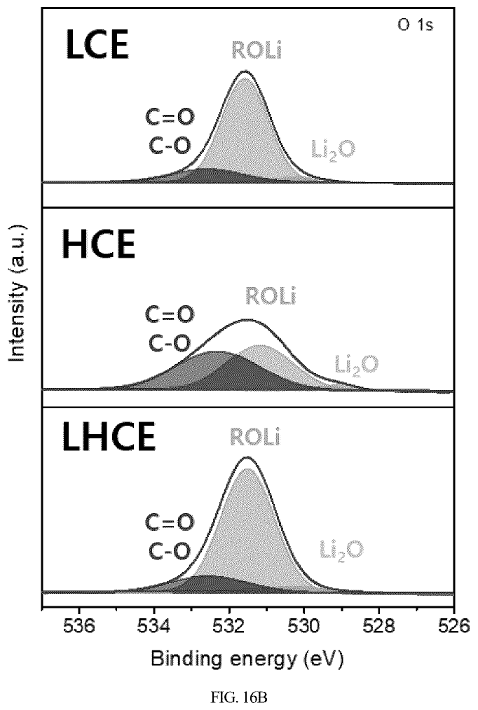

FIG. 14 is the working electrode images after 1 hour of electrochemical reaction at 20 bar N₂ in Comparative Example 1 (LCE), Comparative Example 2 (HCE), and Example 1-3 of the present disclosure (LHCE) and FIG. 15 shows XRD data of each electrode of Comparative Example 1 (LCE), Comparative Example 2 (HCE), and Example 1-3 of the present disclosure (LHCE) after 1 hour of electrochemical reaction.

Referring to FIGS. 14 and 15, a thick and non-uniform SEI was formed in LCE where solvent-rich solvation was dominant, but in HCE and LHCE where anion-rich solvation was dominant, the SEI was formed so thinly and uniformly that it was not visible to the eye, and it was confirmed that this was not observed even in XRD that detects crystalline substances.

### Test Example 8: XPS Analysis

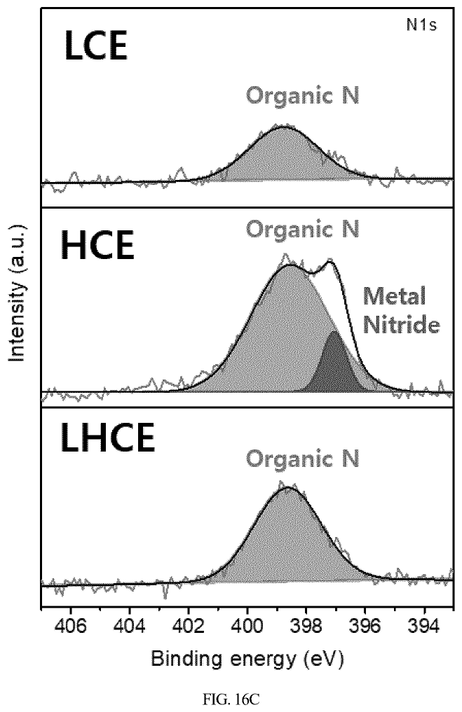

FIGS. 16A to 16C are XPS spectra of C 1s, O 1s, and N 1s of SEI in each electrolyte of Comparative Example 1 (LCE), Comparative Example 2 (HCE), and Example 1-3 of the present disclosure (LHCE), respectively.

Referring to FIG. 16, it was confirmed that the amount of Li₂CO₃, a carbon-based byproduct, was reduced in the SEI of HCE and LHCE, and that the ROLi-based material found in LHCE was a factor in forming the porous SEI.

The scope of the present disclosure is defined by the following claims rather than the above detailed description, and all changes or modifications derived from the meaning and scope of the claims and their equivalent concepts should be interpreted as falling into the scope of the present disclosure.

What is claimed is:

1. An electrolyte comprising a first solvent represented by Structural Formula 1 below;
a second solvent represented by Structural Formula 2 below;
a metal salt; and
a proton donor compound, 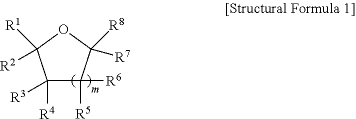
wherein R¹ to R⁸ are identical to or different from each other, and R¹ to R⁸ are each independently a hydrogen atom or a C₁-C₃ alkyl group,
m is 1 or 2, 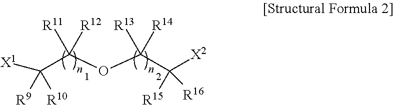
X¹ is F, Cl, Br or I,
R⁹ and R¹⁰ are identical to or different from each other, and R⁹ and R¹⁰ are each independently a hydrogen atom, F, Cl, Br or I,
R¹¹ and R¹² are identical to or different from each other, and R¹¹ and R¹² are each independently a hydrogen atom, F, Cl, Br or I,
R¹³ and R¹⁴ are identical to or different from each other, and R¹³ and R¹⁴ are each independently a hydrogen atom, F, Cl, Br or I,
X² is F, Cl, Br or I,
R¹⁵ and R¹⁶ are identical to or different from each other, and R¹⁵ and R¹⁶ are each independently a hydrogen atom, F, Cl, Br or I,
n₁ is any integer from 0 to 7, and
n₂ is any integer from 0 to 7.

2. The electrolyte of claim 1,
wherein R¹ to R⁸ are identical to or different from each other, and R¹ to R⁸ are each independently a hydrogen atom or a methyl group,
m is 1 or 2,
X¹ is F,
R⁹ and R¹⁰ are identical to or different from each other, and R⁹ and R¹⁰ are each independently a hydrogen atom or F,
R¹¹ and R¹² are identical to or different from each other, and R¹¹ and R¹² are each independently a hydrogen atom or F,
R¹³ and R¹⁴ are identical to or different from each other, and R¹³ and R¹⁴ are each independently a hydrogen atom or F,
X² is F,
R¹⁵ and R¹⁶ are identical to or different from each other, and R¹⁵ and R¹⁶ are each independently a hydrogen atom or F,
n₁ is any integer from 0 to 5, and
n₂ is any integer from 0 to 5.

3. The electrolyte of claim 1,
wherein R¹ to R⁸ are each a hydrogen atom,
m is 1,
X¹ is F,
R⁹ and R¹⁰ are identical to or different from each other, and R⁹ and R¹⁰ are each independently a hydrogen atom or F,
R¹¹ and R¹² are identical to or different from each other, and R¹¹ and R¹² are each independently a hydrogen atom or F,
R¹³ and R¹⁴ are identical to or different from each other, and R¹³ and R¹⁴ are each independently a hydrogen atom or F,
X² is F,
R¹⁵ and R¹⁶ are identical to or different from each other, and R¹⁵ and R¹⁶ are each independently a hydrogen atom or F,
n₁ is any integer from 0 to 3, and
n₂ is any integer from 0 to 3.

4. The electrolyte of claim 1, wherein the electrolyte is used in an electrochemical ammonia production system.

5. The electrolyte of claim 1, the electrolyte comprising:
100 parts by weight of the first solvent represented by the Structural Formula 1;
100 to 400 parts by weight of the second solvent represented by the Structural Formula 2;
50 to 250 parts by weight of the lithium salt; and
1 to 10 parts by weight of the proton donor compound.

6. The electrolyte of claim 1, wherein a volume ratio of the second solvent and the first solvent is 0.1:1 to 9:1.

7. The electrolyte of claim 1, wherein a concentration of the metal salt is 0.5 to 5 M based on a total of the first solvent and the second solvent.

8. The electrolyte of claim 1, wherein a dielectric constant of the second solvent is smaller than that of the first solvent, and a dipole moment of the second solvent is smaller than that of the first solvent.

9. The electrolyte of claim 1, wherein the second solvent interferes with solvation of a metal ion of the metal salt.

10. The electrolyte of claim 1, wherein the metal salt comprises at least one selected from the group consisting of a lithium salt, a zinc salt, a sodium salt, a nickel salt, a calcium salt, and a magnesium salt.

11. The electrolyte of claim 10, wherein the lithium salt comprises at least one selected from the group consisting of lithium bisfluorosulfonylimide (Li(FSO₂)₂N), LiFSI), lithium hexafluorophosphate (LiPF₆), lithium tetrafluoroborate (LiBF₄), lithium perchlorate (LiClO₄), lithium trifluoromethanesulfonylimide (LiN(CF₃SO₂)₂, LiTFSI), lithium triflate (LiCF₃SO₃), lithium difluoro(bis(oxalato))phosphate (LiPF₂(C₂O₄)₂), lithium tetrafluoro(oxalato)phosphate (LiPF₄(C₂O₄)), lithium difluoro(oxalato)borate (LiBF₂(C₂O₄)), and lithium bis(oxalato)borate (LiB(C₂O₄)₂).

12. The electrolyte of claim 1, wherein the proton donor compound comprises at least one selected from the group consisting of ethanol, methanol, isopropanol, n-propanol, n-butanol, glycol, propylene glycol, glycerol, butane diol, ammonia, formic acid, acetic acid, and water.

13. An ammonia production system, the system comprising a working electrode, a counter electrode, a reference electrode, and an electrolyte,
wherein the electrolyte comprises:
a first solvent represented by Structural Formula 1 below;
a second solvent represented by Structural Formula 2 below;
a metal salt; and
a proton donor compound, 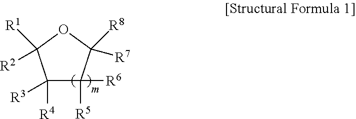
wherein R¹ to R⁸ are identical to or different from each other, and R¹ to R⁸ are each independently a hydrogen atom or a C₁-C₃ alkyl group,
m is 1 or 2, 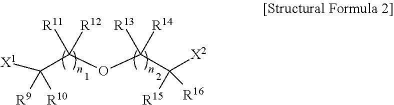
X¹ is F, Cl, Br or I,
R⁹ and R¹⁰ are identical to or different from each other, and R⁹ and R¹⁰ are each independently a hydrogen atom, F, Cl, Br or I,
R¹¹ and R¹² are identical to or different from each other, and R¹¹ and R¹² are each independently a hydrogen atom, F, Cl, Br or I,
R¹³ and R¹⁴ are identical to or different from each other, and R¹³ and R¹⁴ are each independently a hydrogen atom, F, Cl, Br or I,
X² is F, Cl, Br or I,
R¹⁵ and R¹⁶ are identical to or different from each other, and R¹⁵ and R¹⁶ are each independently a hydrogen atom, F, Cl, Br or I,
n₁ is any integer from 0 to 7, and
n₂ is any integer from 0 to 7.

14. The ammonia production system of claim 13,
wherein R¹ to R⁸ are identical to or different from each other, and R¹ to R⁸ are each independently a hydrogen atom or a methyl group,
m is 1 or 2,
X¹ is F,
R⁹ and R¹⁰ are identical to or different from each other, and R⁹ and R¹⁰ are each independently a hydrogen atom or F,
R¹¹ and R¹² are identical to or different from each other, and R¹¹ and R¹² are each independently a hydrogen atom or F,
R¹³ and R¹⁴ are identical to or different from each other, and R¹³ and R¹⁴ are each independently a hydrogen atom or F,
X² is F,
R¹⁵ and R¹⁶ are identical to or different from each other, and R¹⁵ and R¹⁶ are each independently a hydrogen atom or F,
n₁ is any integer from 0 to 5, and
n₂ is any integer from 0 to 5.

15. The ammonia production system of claim 13, wherein an ammonia is produced at the working electrode and a hydrogen is produced at the counter electrode.

16. The ammonia production system of claim 13, wherein the working electrode comprises a nickel atom, the counter electrode comprises a platinum atom, and the reference electrode comprises a platinum atom.

17. A method of producing an ammonia, the method comprising:
(a) supplying an ammonia production system; and
(b) supplying a nitrogen to the ammonia production system to perform a reduction reaction, thereby producing an ammonia,
wherein the system comprises a working electrode, a counter electrode, a reference electrode, and an electrolyte,
wherein the electrolyte comprises:
a first solvent represented by Structural Formula 1 below;
a second solvent represented by Structural Formula 2 below;
a metal salt; and
a proton donor compound, 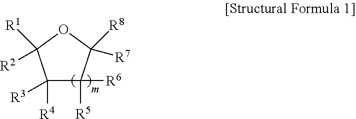
wherein R¹ to R⁸ are identical to or different from each other, and R¹ to R⁸ are each independently a hydrogen atom or a C₁-C₃ alkyl group,
m is 1 or 2, 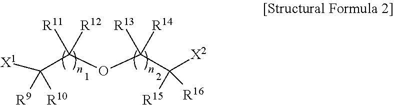
X¹ is F, Cl, Br or I,
R⁹ and R¹⁰ are identical to or different from each other, and R⁹ and R¹⁰ are each independently a hydrogen atom, F, Cl, Br or I,
R¹¹ and R¹² are identical to or different from each other, and R¹¹ and R¹² are each independently a hydrogen atom, F, Cl, Br or I,
R¹³ and R¹⁴ are identical to or different from each other, and R¹³ and R¹⁴ are each independently a hydrogen atom, F, Cl, Br or I,
X² is F, Cl, Br or I,
R¹⁵ and R¹⁶ are identical to or different from each other, and R¹⁵ and R¹⁶ are each independently a hydrogen atom, F, Cl, Br or I,
n₁ is any integer from 0 to 7, and
n₂ is any integer from 0 to 7.

18. The method of producing an ammonia of claim 17, wherein the reduction reaction is carried out by lithium-mediated nitrogen reduction (Li-NRR).

19. The method of producing an ammonia of claim 17, wherein a nitrogen is supplied at a pressure of 5 to 25 bar.
